(19) United States
(12) Patent Application Publication
(10) Pub. No.: US 2002/0153751 A1
(43) Pub. Date: Oct. 24, 2002

(54) Hatch for an opening in a fixed motor vehicle roof surface

(76) Inventors: Jorn Lenhardt, Neustrelitz (DE); Hans-Michael Wardenga, Neddemin (DE); Helmut Stenzel, Neubrandenburg (DE); Dieter Schulz, Neubrandenburg (DE)

Correspondence Address: NIXON PEABODY, LLP, 8180 GREENSBORO DRIVE, SUITE 800, MCLEAN, VA, 22102, US

(21) Appl. No.: 09/866,542

(22) Filed: May 29, 2001

(30) Foreign Application Priority Data
May 26, 2000 (DE) 100 25 950.2

(51) Int. Cl. B60J 7/00; B60R 13/02

(52) U.S. Cl. 296/214

(57) ABSTRACT

A hatch for an opening in a fixed roof surface of a motor vehicle such as a bus, commercial vehicle or camping vehicle. The hatch includes a frame for insertion into the roof opening, a selectively movable cover supported by the frame, and a lining for at least partially covering or clearing the roof opening or the cover. The lining is attached roof-mounted by way of a connecting site which is made such that the lining can be manually removed without a tool in order to at least partially clear the roof opening or the cover.

### BACKGROUND OF THE INVENTION

1. Field of the Invention

The present invention is directed generally to a roof hatch for an opening in a fixed roof surface of a motor vehicle such as a bus, a commercial motor vehicle or a motor vehicle used for camping.

2. Description of the Prior Art

One such conventional roof hatch is known, for example, from published German Patent Application DE 44 44 038 A1 and includes a cover formed by a glass pane, underneath which is an inside cover which acts as a lining and which has a window-like opening which makes the cover accessible for smashing using an emergency hammer to accomplish an emergency escape function. The lining is attached securely to the glass cover and when the glass cover is raised is moved with it at the same time for ventilation purposes. As a result of this secure connection of the lining to the cover, when the cover is selectively raised for ventilation purposes, a peripheral ventilation gap is formed by which foreign bodies falling onto the motor vehicle roof can penetrate the passenger compartment unhindered. Furthermore, when the cover is selectively closed, there is the danger that body parts, especially hands, can be pinched in the peripheral gap. To prevent this occurrence from happening, there must be pinch protection in a complex manner. Furthermore, due to the fact that the lining must be raised and lowered each time with the cover, higher demands must be placed on the drive of the cover.

U.S. Pat. No. 1,480,274 discloses covering a motor vehicle roof cover which can be selectively raised for ventilation purposes and which has an air-permeable lining which is securely mounted in an nondetachable manner on the inside of the fixed motor vehicle roof. In this structure, however, there is no easy accessibility of the cover, for implementing an emergency escape function.

### SUMMARY OF THE INVENTION

In view of the foregoing, it is an object of the present invention to provide a hatch for an opening in a fixed motor vehicle roof surface which, in normal operation, allows secure covering of a selectively movable cover or the roof opening and still easily allows, if necessary, prompt access to the cover and the roof opening.

These and other objects are achieved in accordance with the present invention by a roof hatch having a frame which can be inserted into the roof opening, a selectively movable cover for at least partially covering the roof opening, the cover being supported by the frame, and a lining for covering at least one of the roof opening and the cover, whereby the lining is attached roof-mounted using a connecting site which is made such that the lining can be selectively removed manually without a tool in order to at least partially clear at least one of the roof opening and the cover.

Such a design is advantageous since, during normal operation, the roof opening or the cover is completely concealed from the vehicle interior so, that with the cover raised, articles cannot fall inside the motor vehicle. In addition, there is no danger of pinching of body parts. Lastly, such a design allows necessary prompt and easy access to the cover or the roof opening is possible in order to implement an emergency escape function.

### BRIEF DESCRIPTION OF THE DRAWINGS

FIG. 1 is a sectional view of a roof hatch in the installed state in a first embodiment of the invention;

FIG. 2 shows a view of the hatch from FIG. 1 from the vehicle interior;

FIG. 3 is hows a sectional view of a roof hatch in the installed state in a second embodiment of the present invention; and

FIG. 4 shows a view of the hatch from FIG. 3 from the vehicle interior.

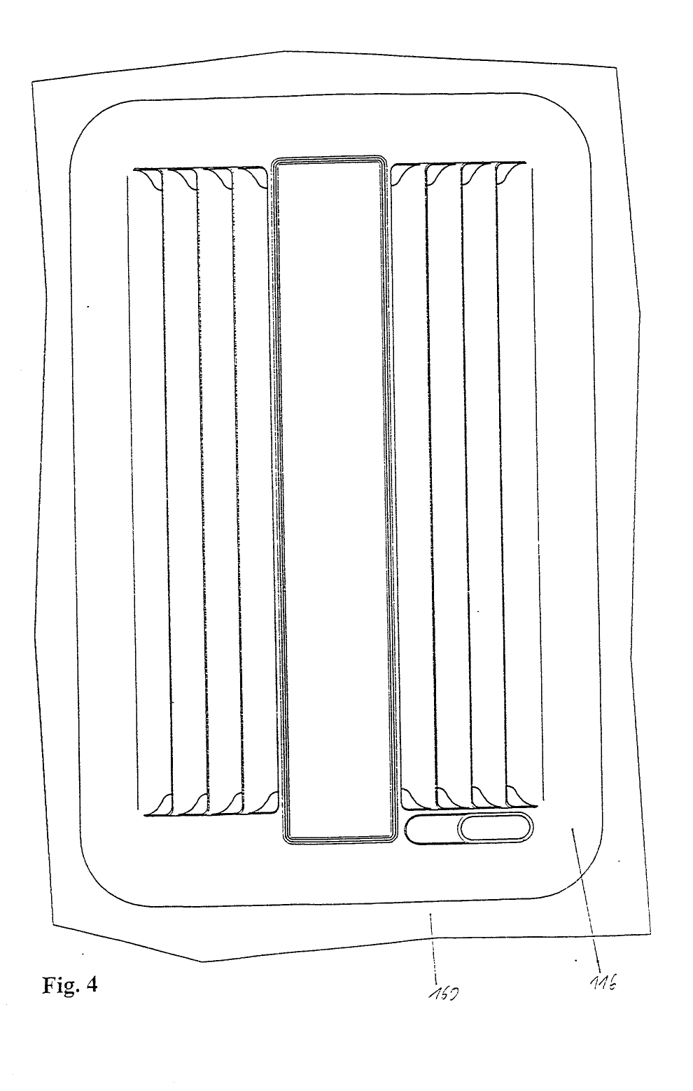

### DETAILED DESCRIPTION OF THE PREFERRED EMBODIMENTS

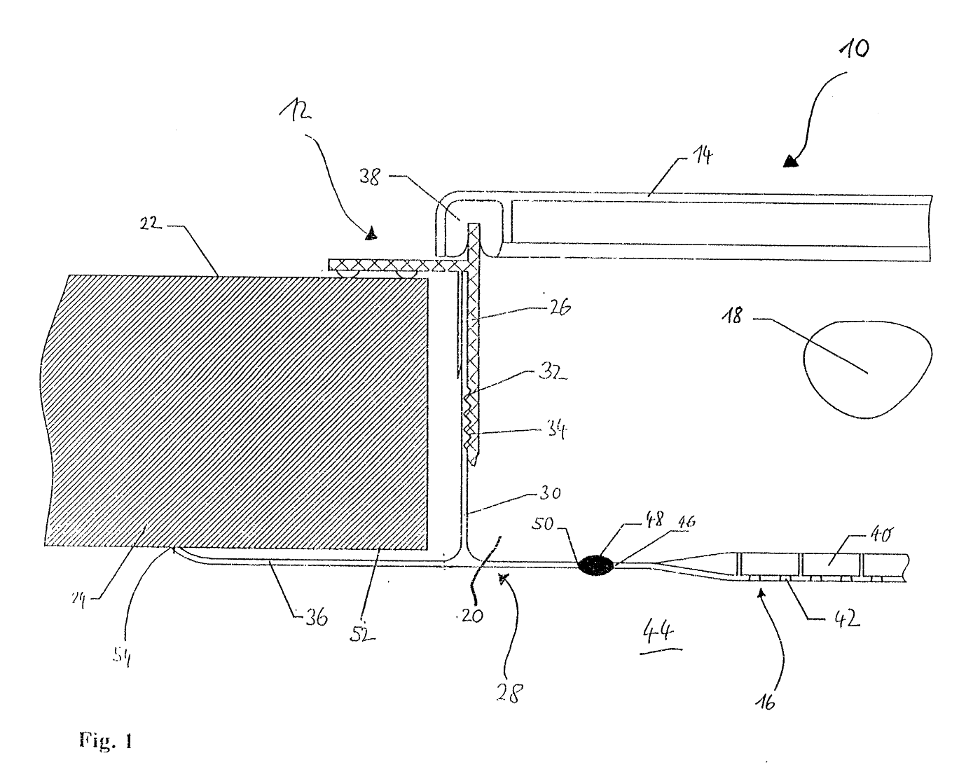

FIGS. 1 & 2 show a first embodiment of the invention which includes an opening 20 in a fixed roof surface 22 of a motor vehicle roof 24 into which a hatch 10 is inserted. The roof hatch 10 includes a frame 12, a cover 14, and a lining 16. As schematically shown in FIG. 1, the hatch 10 also includes an emergency release device 18 connected to the cover 14 and lining 16 for releasing the hatch 10 and thereby allowing passengers inside the motor vehicle to make an emergency exit from the motor vehicle through the opening 20 of the fixed roof surface 22.

The frame 12 is made essentially in two parts and includes a main frame 26 and an inside frame extension 28 which engages the main frame 26 by catching or clamping via a vertical edge 30. Attached to the vertical edge 30 of the extension 28 are catch or clamp elements 32 which are received into a corresponding opposite side 34 of the main frame 26 to thereby connect the extension 28 to the main frame 26. The main frame 26 and the inside frame extension 28 are provided with an edge ring 36 which extends around the fixed roof 24. Preferably, the main frame 26 is sealed to the fixed roof surface 22. The frame 12 can be easily used for different roof thicknesses by the catch connection between the main frame 26 and the inside frame 28. In the closed state, the cover 14 rests on the top of the main frame 26 via a seal 38. The cover 14 preferably can be selectively raised for a ventilation purposes by way of a raising mechanism (not shown).

The lining 16 includes a surface 40 which is made as an air-permeable unit 42 designed so as not to allow body parts to reach through and which is structurally stable so that it can prevent articles from penetrating from overhead through the ventilation gap in the raised state of the cover 14 into the motor vehicle interior 44. The surface 40 can be matched in its design to the passenger compartment 44. In an edge area 46, the air-permeable unit 42 is connected via a separating or connecting site 48 to the inside edge 50 of the horizontally running edge ring 36 of the inside frame 28. The separating site 48 is made peripheral with respect to the lining unit 42 and allows manually detachment without the aid of a tool, and thus, selective separation of the lining 16 for an emergency situation or in performing repairs. By removing the lining 16, the cover 14 or the roof opening 20 is at least partially cleared, the opening formed by removing the lining 16 to enable emergency escape. The separating site 48, which can also be called a connection area, is made such that repeated detachment and re-attachment of the lining 16 to the inside frame 28 are possible. In this manner, the separating site 48 can be made in the form of a zip fastener, a clip fastener or a velcro fastener.

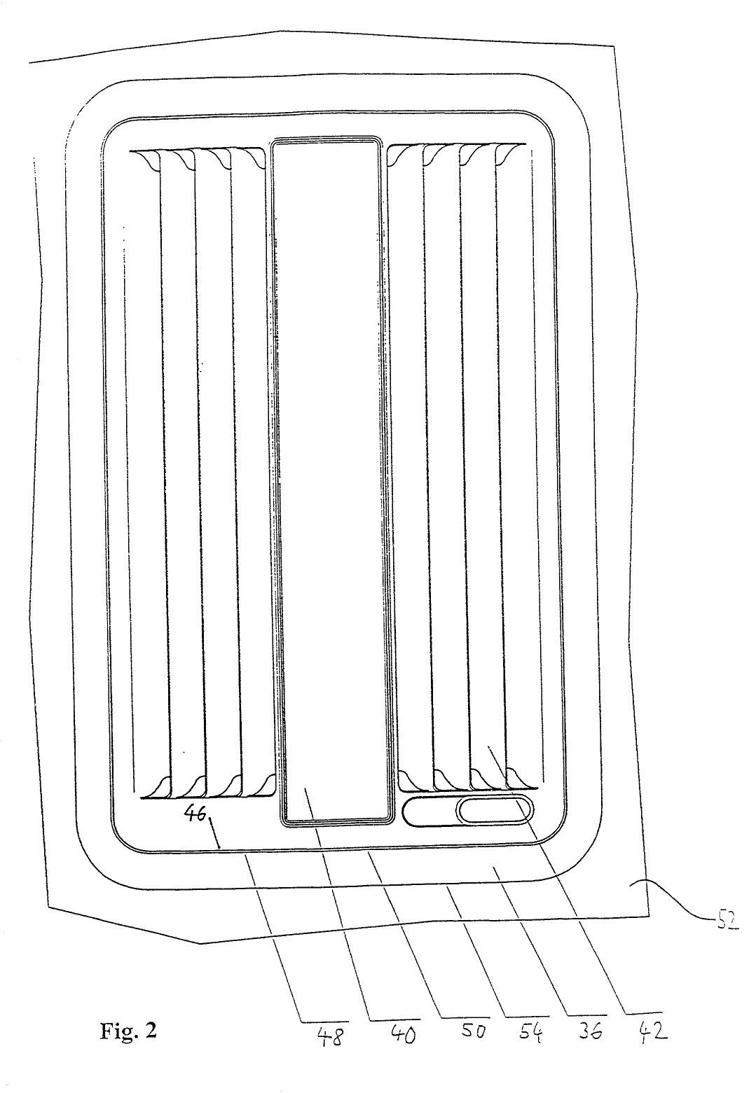

In addition to the lining 16, the edge ring 36 assumes the lining function relative to the interior 28, in the edge area of the roof opening 20 not encompassed by the lining 16. The vertically adjustable catch or clamp connection between the main frame 26 and the inside frame 26 makes it possible to equalize different roof thicknesses in a relative large range with a single configuration of the lining, leveling to the inside 52 of the roof. Reference number 54 labels the peripheral edge of the edge ring 36 in FIGS. 1 and 2.

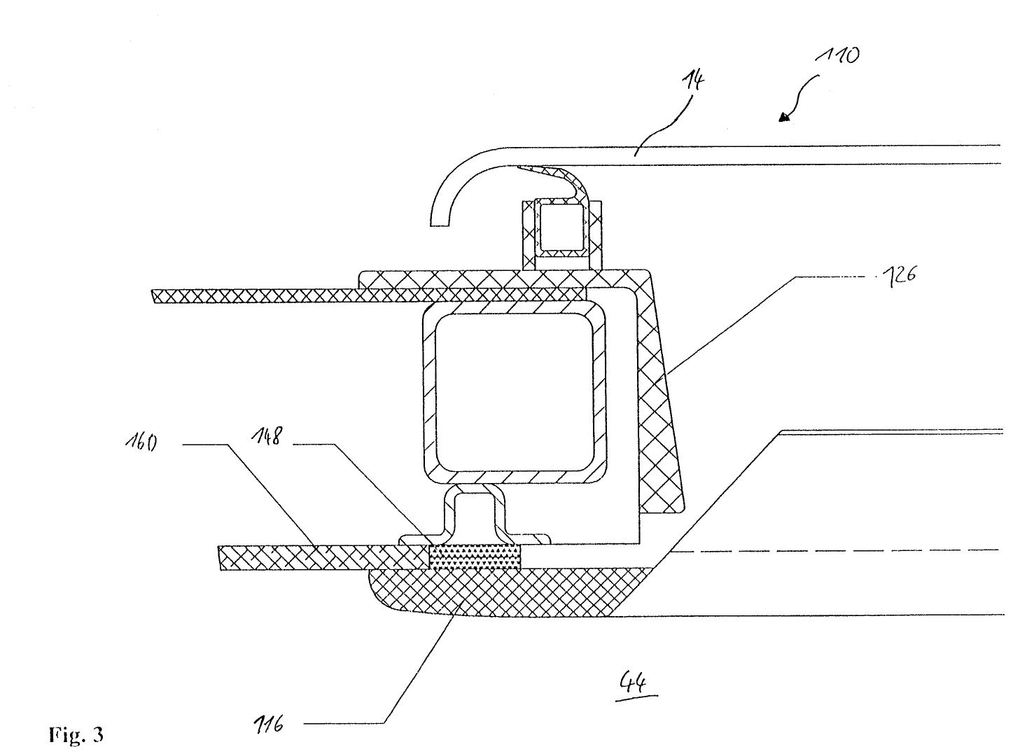

An alternative embodiment shown in FIGS. 3 & 4 differs essentially from the embodiment shown in FIGS. 1 & 2 in that the detachable lining 116 is not attached to the frame 126 of the roof hatch 110, but is detachably mounted on the cover 160 of the passenger compartment 44. For this purpose, there is a separating or a connecting area 148 which enables repeated, nondestructive connection and detachment of the lining 1 16 to and from the passenger compartment cover 160 in a manner similar to the above described embodiment.

Both embodiments of the invention may include a primary detector mechanism (not shown) for detecting when the connection between the liner and the connecting site is disconnected or loosened, and a signal means (not shown) electrically connected to the primary detector and which receives a signal from the primary detector when the connection between the liner and the connecting site is disconnected or loosened.

The primary detector may also activate the motorized drive to automatically close the cover.

What is claimed is:

1. A hatch for a fixed motor vehicle roof surface having a roof opening, said hatch comprising:
a frame adapted to be disposed in the roof opening;
a cover for the roof opening, said cover being supported by said frame and being selectively movable to at least partially cover the roof opening;
a lining for at least partially covering the roof opening or the cover; and
connection means for detachably connecting said lining to the fixed motor vehicle roof surface to allow said lining to be selectively removed without aid of a tool to at least partially clear the roof opening or the cover and thereby enable emergency egress from the motor vehicle by a passenger.

2. The hatch as claimed in claim 1, wherein said connection means detachably connects said lining to said frame.

3. The hatch as claimed in claim 2, wherein said connection means is adapted to detachably connect said lining to an inside lining of the fixed motor vehicle roof surface.

4. The hatch as claimed in claim 3, wherein said cover is pivotally supported by said frame for selective pivotal movement to enable ventilation of an interior space of the motor vehicle.

5. The hatch as claimed in claim 4, wherein said lining is air-permeable to enable ventilation of the interior space of the motor vehicle.

6. The hatch as claimed in claim 5, wherein said connection means allows reattachment of said lining to said motor vehicle after said lining has been removed.

7. The hatch as claimed in claim 6, wherein said connection means extends around a peripheral edge of said lining.

8. The hatch as claimed in claim 7, wherein said connection means is one of a zip fastener, a clip fastener and a hook and loop fastener.

9. The hatch as claimed in claim 8, wherein said frame includes a main frame and an extension member having a plurality of clamping elements for connecting said extension to said main frame.

10. The hatch as claimed in claim 9, further comprising an emergency release device for releasing the hatch to thereby allow passengers inside the motor vehicle to make an emergency exit from the motor vehicle through the roof opening.

11. The hatch as claimed in claim 10, further comprising a detector mechanism for detecting when the connection between said liner and said connecting means is disconnected or loosened, and a signal means electrically connected to said detector mechanism to provide a signal when the connection between said liner and said connecting means is disconnected or loosened.
